(19) United States
(12) Patent Application Publication
(10) Pub. No.: US 2023/0118705 A1
(43) Pub. Date: Apr. 20, 2023

(54) PORTABLE POWER SUPPLY WITH REMOVABLE OUTLET PANEL

(71) Applicant: MILWAUKEE ELECTRIC TOOL CORPORATION, Brookfield, WI (US)

(72) Inventors: Jacob R. Wenzlick, Milwaukee, WI (US); Phillip R. Nensel, Wauconda, IL (US); Andrew P. Rux, Greendale, WI (US); Kyle R. Becker, Brookfield, WI (US); Michael A. Matthews, Milwaukee, WI (US); Anthony S. Graykowski, Belgium, WI (US)

(21) Appl. No.: 17/969,222

(22) Filed: Oct. 19, 2022

Related U.S. Application Data
(60) Provisional application No. 63/257,644, filed on Oct. 20, 2021.

(51) Int. Cl. H02J 7/00; H02J 7/02

(52) U.S. Cl. CPC H02J 7/0045; H02J 7/02; H02J 7/0047; H02J 7/0063; H02J 2207/20; H02J 2207/30

(57) ABSTRACT

A portable power supply has a housing, a plurality of battery cells, a sensor, an inverter, and a modular outlet panel. The housing defines an opening and a cavity therein. The battery cells are disposed in the cavity. The sensor is electrically coupled to the battery cells. The inverter is electrically coupled to the battery cells. The inverter is disposed in the cavity. The modular outlet is removably coupled to the housing. The modular outlet panel is disposed over a majority of the opening.

### CROSS-REFERENCE TO RELATED APPLICATIONS

This application claims priority to co-pending U.S. Provisional Patent Application No. 63/257,644, filed on Oct. 20, 2021, the entire contents of which are incorporated herein by reference.

### BACKGROUND

The present disclosure relates to a portable power supply, and, in particular, a portable power supply with an outlet panel that is removable.

A portable power supply may include many different types of electrical outlets for connecting a variety of connectors of power cords. The connector type used by a specific power tool or light equipment apparatus often depends on the region in the world in which the tool is sold. The present disclosure provides a power supply to which an outlet panel with an appropriate electrical outlet can be removably connected.

### SUMMARY

The disclosure provides, in one aspect, a portable power supply with a removable outlet panel connected thereto. The portable power supply has a housing with a recess and a cavity. Inside the cavity are a plurality of battery cells. An electrical sensor is electrically coupled to the battery cells. An inverter is also disposed in the cavity and is electrically connected to the battery cells. A receptacle is also disposed in the housing and electrically coupled to the battery cells. An outlet panel with an outlet is electrically coupled to the inverter, with the outlet panel being removably coupled to the housing. The outlet panel covers a majority of the recess and detects the sensor. Also disposed in the housing is a junction box that has a recess and perimeter.

The disclosure provides, in another aspect, a portable power supply to which a removable outlet panel can be connected. The portable power supply has a housing with a cavity, a junction box, and a receptacle. The junction box has a plurality of walls that define a recess, and a hole is defined in at least one of the walls that allows fluid communication between the recess and the cavity. A plurality of batteries are disposed in the cavity. A sensor adjacent at least one of the walls of the junction box is electrically coupled to the plurality of battery cells. The receptacle is electrically coupled to the battery cells. An inverter is also disposed in the cavity and is electrically coupled to the battery cells.

The disclosure provides, in another aspect, a portable power supply with a removable outlet panel connected thereto. The portable power supply includes a housing, a plurality of battery cells, an inverter, a junction box, and removable outlet panel, a plurality of wires, a display, and a frame. The housing defines a cavity. The battery cells are disposed in the cavity. An inverter is also disposed in the cavity and is electrically coupled to the plurality of battery cells. The junction box has a plurality of walls with a hole in at least one of the walls. The walls define a recess. The hole fluidly communicates the recess of the junction box with the cavity. The removable outlet panel is removably connected to the junction box by a plurality of fasteners. A plurality of wires electrically couple the outlet panel to the inverter. The frame surrounds the housing.

Other features and aspects of the disclosure will become apparent by consideration of the detailed description and accompanying drawings.

### BRIEF DESCRIPTION OF THE DRAWINGS

FIG. 1 is a front elevation view of a portable power supply according to embodiments disclosed herein.

FIG. 2 is a detailed bottom perspective view of a sensor of the portable power supply of FIG. 1.

FIG. 3 is a front elevation view of the portable power supply of FIG. 1.

FIG. 4 is a detailed perspective view of an outlet panel of the portable power supply of FIG. 1.

FIG. 5 is a detailed perspective view of the portable power supply of FIG. 1, showing the outlet panel removed.

FIG. 6 is an exploded perspective view of a junction box and outlet panel of the portable power supply of FIG. 1.

FIG. 7 is a detailed front perspective view of the sensor of the portable power supply of FIG. 1.

FIG. 8 is an exemplary electrical signal diagram of a portable power supply according to embodiments disclosed herein.

FIG. 9 is a front elevation view of a portable power supply according to embodiments disclosed herein.

FIG. 10 is a detailed perspective view of the portable power supply of FIG. 9, showing the outlet panel removed.

FIG. 11 is a front elevation view of a portable power supply according to embodiments disclosed herein.

FIG. 12A is an exemplary electrical signal diagram according to embodiments disclosed herein.

FIG. 12B is a continuation of the exemplary electrical signal diagram of FIG. 12A.

FIG. 13A is an exemplary wiring harness diagram of the portable power supply according to embodiments disclosed herein.

FIG. 13B is a continuation of the exemplary wiring harness diagram of FIG. 13A.

### DETAILED DESCRIPTION

Before any embodiments of the disclosure are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

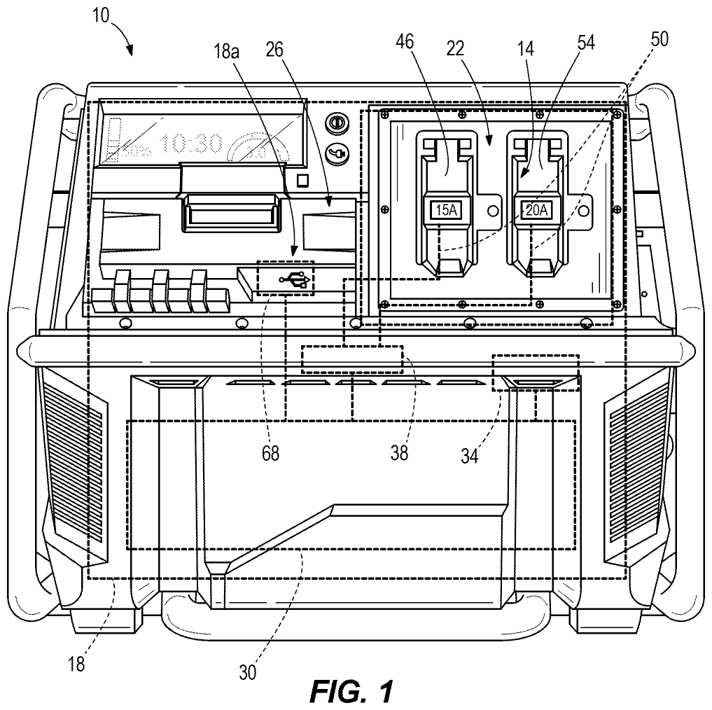

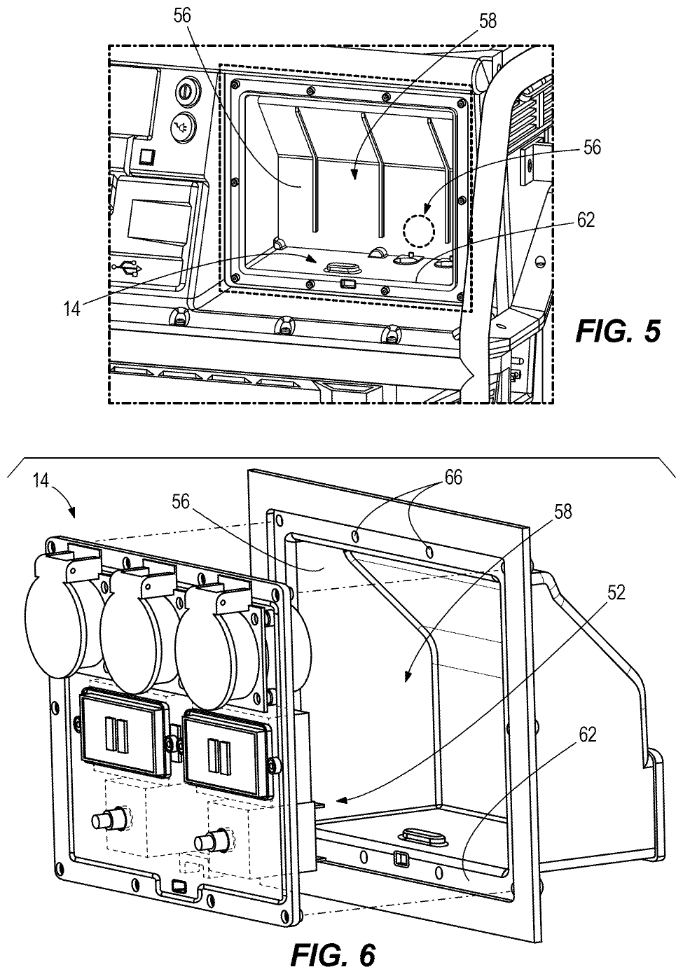

FIG. 1 illustrates an embodiment of portable power supply 10. The portable power supply 10 has a housing 18 and a modular outlet panel 14 attached to the housing 18. The portable power supply 10 is suitable for providing power at a remote location such as a worksite. Where a permanent power supply such as mains power is not available, and power is required in order to operate electrically powered tools, the portable power supply 10 may provide power to be used by those tools. The portable power supply 10 may provide alternating current (AC) power to tools such as corded drills, saws, and the like and battery-charging units and/or direct current (DC) power for DC-powered tools. The housing 18 of the portable power supply 10 has an opening 22, for instance at the front face 18a, and a cavity 26 inside the housing 18. The housing 18 is a durable material, such as metal, plastic, or the like, that is capable of withstanding scratches, dents, or other similar wear common to a worksite. Disposed in the cavity 26 are a plurality of battery cells 30, for instance, lithium ion battery cells or the like. The battery cells 30 are capable of being recharged, for instance by using mains electric power as a power source to recharge the battery cells 30. As shown in FIG. 5, a receptacle 32 is disposed in the housing 18 for facilitating charging of the battery cells 30. The receptacle 32 is electrically coupled to the battery cells 30. An external power source such as mains electric power is coupled to the receptacle 32 by a power cord or other power transmission apparatus.

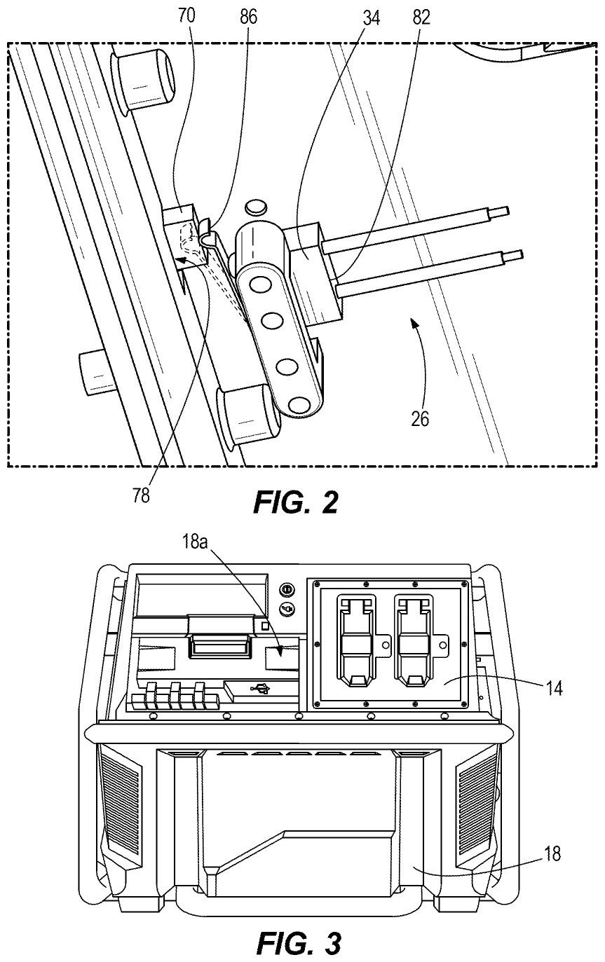

A sensor 34 is electrically coupled to the battery cells 30. As illustrated in FIG. 2, the sensor 34 is a mechanical switch 34. Alternatively, the sensor 34 could be a Hall effect sensor, infrared sensor, or the like. Returning to FIG. 1, the sensor 34 in the present embodiment is disposed in the cavity 26 of the housing 18. The detection of the sensor 34 will be described in further detail below.

An inverter 38 is also disposed in the cavity 26 of the housing 18. The inverter 38 is electrically coupled to the plurality of battery cells 30 for converting the direct current provided by the battery cells 30 to an alternating current that can be used to operate AC-powered tools that would typically require a connection to a mains electric power supply.

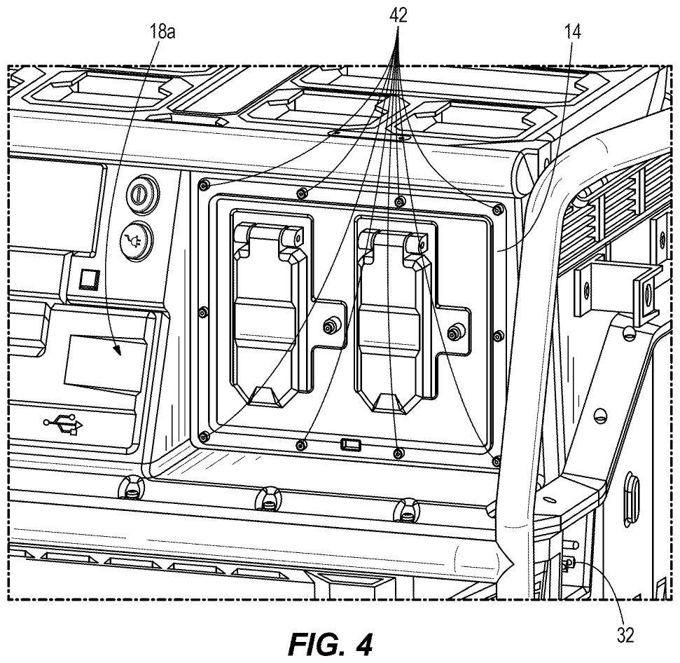

The modular outlet panel 14 is removably coupled to the housing 18. In the present embodiment as illustrated in FIGS. 3 and 4, the outlet panel 14 is connected to the front face 18a of the housing 18. The outlet panel 14 is connected to the housing 18 by a plurality of fasteners 42. The present embodiment includes ten screws for removably attaching the modular outlet panel 14 to the housing 18. Other quantities and types of fasteners can be used, such as bolts, clips, or the like. The outlet panel 14 covers at least a majority of the opening 22. As shown in the present embodiment, the outlet panel 14 covers the entirety of the opening 22.

Returning to FIG. 1, the portable power supply 10 also includes an outlet 46. The outlet 46 may be removably connected to the modular outlet panel 14. The outlet 46 is electrically coupled to the inverter 38, for instance, by a plurality of wires 50. The electrical connection of the outlet 46 via the plurality of wires 50 provides an AC power supply to the outlet 46. The battery cells 30 provide DC power to the inverter 38 which is converted from DC power to AC power. The AC power is provided to the modular outlet panel 14 and the outlet 46 via the plurality of wires 50. The plurality of wires 50 can be connected to the outlet 46 at a screw terminal 52. The outlet 46 is connected to the outlet panel 14 by an appropriate method, for instance, by a snap feature, a threaded fastener, or the like. The outlet 46 may be a grounded parallel-blade outlet, such as a National Electrical Manufacturers Association (NEMA) 5-15R outlet or other similar outlet that meets standards set by the NEMA for use in the United States. The outlet 46 may also be an outlet used outside the United States in other regions of the world, such as a CEE 7/3 socket or other socket that accepts CEE Publication 7 consistent plugs. More than one outlet 46 may be provided, with multiples of the same outlet or a variety of different outlets, for instance, one outlet with a fifteen amp maximum current rating and a second outlet with a twenty amp maximum current rating. Other combinations may be used. A modular outlet panel 14 including a NEMA-compliant outlet 46 may be replaced with a modular outlet panel 14 including a non-NEMA compliant outlet 46 used elsewhere in the world. The outlet panel 14 may also include other electrical components, such as a circuit breaker, ground fault circuit interrupter, or the like.

The portable power supply 10 may also include a USB outlet 68, disposed in the housing 18. The USB outlet 68 is connected to the battery cells 30 and can provide DC power to a device, such as a cellular phone, an auxiliary battery charger, or the like when connected to the USB outlet 68. The portable power supply 10 can provide DC power to the USB outlet 68 while concurrently providing AC power to the modular outlet panel 14.

With reference now to FIGS. 5 and 6, a junction box 54 is disposed in the housing 18 behind the outlet panel 14. The junction box 54 includes a recess 58 and a perimeter 62. The perimeter 62 includes a plurality of fastening locations 66. The plurality of fasteners 42 may removably connect the modular outlet panel 14 to the junction box 54 at the plurality of fastening locations 66. An outlet panel 14 may be connected by to the fastening locations 66 by bolts, screws, or other fastening members. The recess 58 of the junction box 54 receives the outlet panel 14. The outlet panel 14 may include protrusions such as outlet connections that project into the recess 58. The junction box 54 includes a hole 56 that communicates the recess 58 with the cavity 26 of the housing 18.

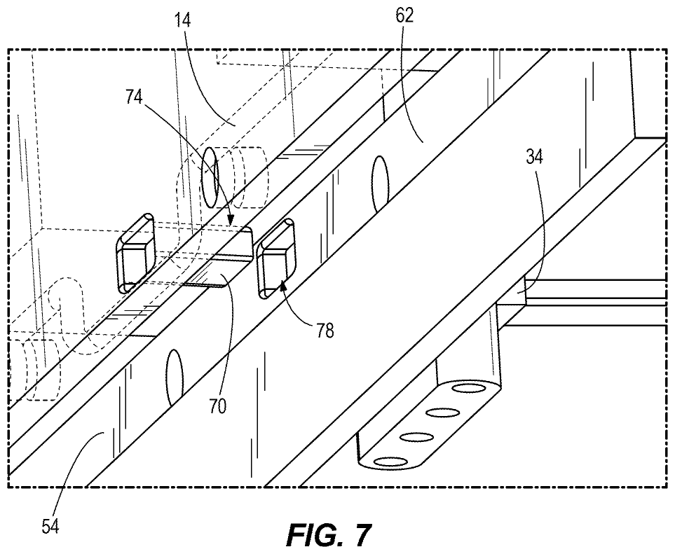

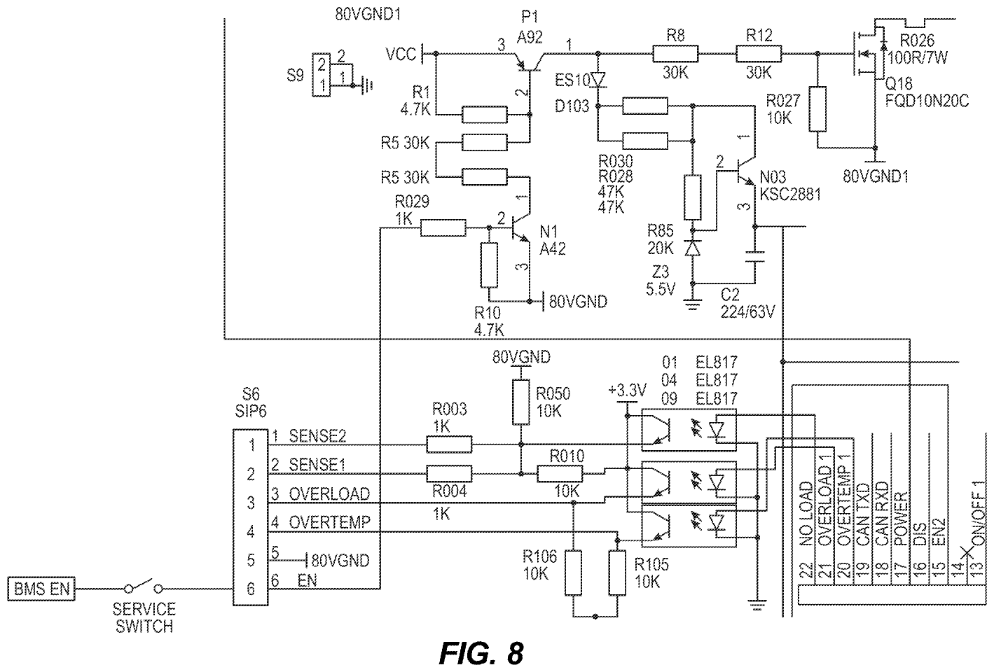

With reference to FIGS. 2 and 7, the detection of the sensor 34 will be further described. The outlet panel 14 detects the sensor 34. In the present illustration, the outlet panel 14 has a boss 70 that extends from the rear face 74 of the outlet panel 14. The perimeter 62 of the junction box 54 includes an aperture 78 that corresponds with the boss 70 on the outlet panel 14 when the outlet panel 14 is connected to the housing 18. The boss 70 projects through the aperture 78 and into the cavity 26 of the housing 18. The sensor 34 is disposed adjacent the aperture 78 in the perimeter 62 of the junction box 54. As illustrated, the sensor 34 is a mechanical switch with a base 82 and a switch arm 86. The boss 70 of the outlet panel 14 projects through the aperture 78 and engages and depresses the switch arm 86 of the switch 34 when the outlet panel 14 is connected to the housing 18 (dashed lines indicate the position of the switch arm 86 when the outlet panel 14 is not connected to the housing 18). As shown in the exemplary diagram in FIG. 8, the sensor 34 provides an electrical signal indicating the presence of the outlet panel 14. The electrical signal is provided when the boss 70 depresses the switch arm 86. When the signal is present, power is supplied to the outlet panel 14 from the battery cells 30 via the inverter 38 and plurality of wires 50. When the boss 70 of the outlet panel 14 does not depress the switch arm 86, the sensor 34 does not provide an electrical signal indicating the presence of the outlet panel 14. When no electrical signal is provided, the battery cells 30, via the inverter 38, cease to provide power to the outlet panel 14.

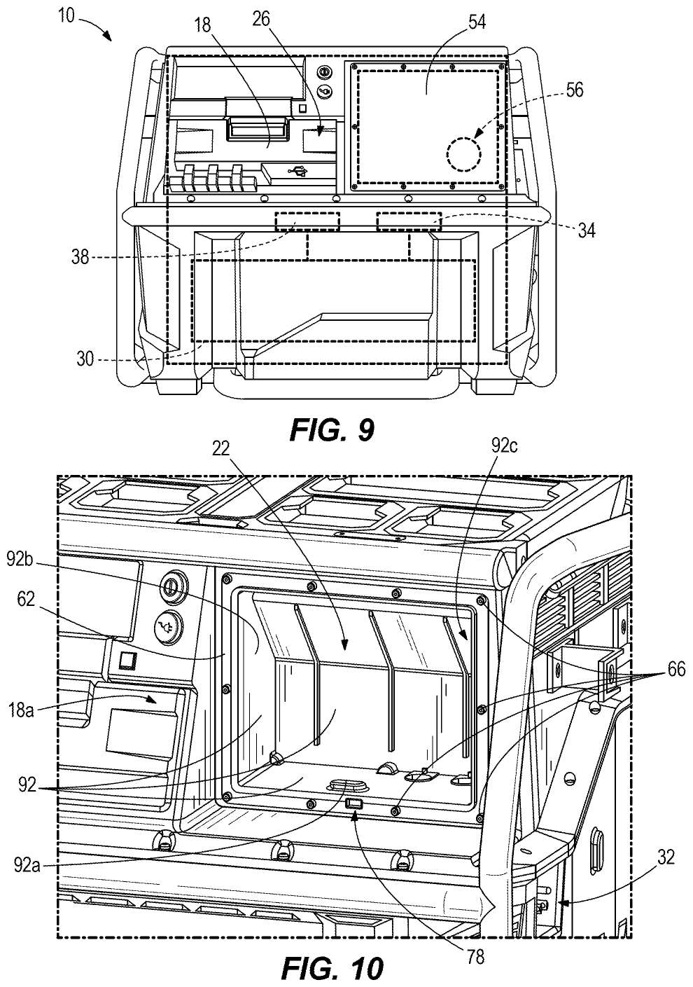

With reference now to FIGS. 9 and 10, an illustration of another embodiment of a portable power supply 10 is shown. The portable power supply 10 includes a housing 18 that includes a cavity 26 and a junction box 54. The housing 18 is made of an appropriate durable material such as metal or plastic that is capable of withstanding scratches, dents, and other minor wear and tear associated with use at a worksite. The junction box 54 has a plurality of walls 92 that extend from the housing 18, such as from the front face 18a, into the cavity 26. The walls 92 defining a recess 58. In at least one of the walls 92 is a hole 56. The hole 56 the recess 58 and the cavity 26. The junction box 54 includes a perimeter 62 surrounding the recess 58. The perimeter 62 includes a plurality of fastening locations 66 to which a modular outlet panel 14 could be attached. The fastening locations 66 may be a plurality of threaded bores for threaded attachment of a plurality of bolts. Alternatively, the fastening locations 66 could accommodate a plurality of screws or another type of appropriate fastener.

A plurality of battery cells 30 is also disposed in the cavity 26 of the housing 18. The battery cells 30 are capable of being recharged when the amount of power the battery cells 30 can provide is depleted. The housing 18 includes a receptacle 32 to which an external power supply such as mains electric power could be connected. The receptacle 32 is electrically coupled to the battery cells 30 to charge the battery cells 30.

An inverter 38 is disposed in the cavity 26 and is coupled to the housing 18. The inverter 38 is electrically coupled to the plurality of battery cells 30. The inverter 38 converts the direct current supplied by the battery cells 30 to an alternating current that can be used to power AC tools such as a corded drill that typically relies on power from mains power from a standard electrical outlet found in a house or business. The inverter 38 may be provided with a plurality of wires 50 for connection to an outlet panel 14 that may be removably connected to the housing 18 of the portable power supply 10.

A sensor 34 is electrically coupled to the battery cells 30. The sensor 34 is disposed adjacent at least one of the plurality of walls 92. In the present embodiment, the sensor 34 is located below and adjacent the lower wall 92a of the junction box 54, approximately equidistant the two vertical side walls 92b, 92c. The sensor 34 may be connected to the junction box 54, housing 18, or another appropriate location.

The sensor 34 may detect the presence or absence of a modular outlet panel 14. When the outlet panel 14 is not attached to the housing 18, the sensor 34 does not provide a signal to indicate the outlet panel 14 is present. When no signal is provided, electrical power is not provided to the plurality of wires 50 that could attach to an outlet panel 14. The housing 18 or junction box 54 may include an aperture 78 through which a boss 70 on an outlet panel 14 may protrude for detecting the sensor 34. A sensor 34 disposed adjacent the aperture 78 may be detected by the boss 70. Activation of the sensor 34 provides a signal indicating the presence of an outlet panel 14. The sensor 34 may be a mechanical switch, with a base 82 and a switch arm 86. The sensor 34 is provides an electrical signal when the switch arm 86 is depressed by the boss 70.

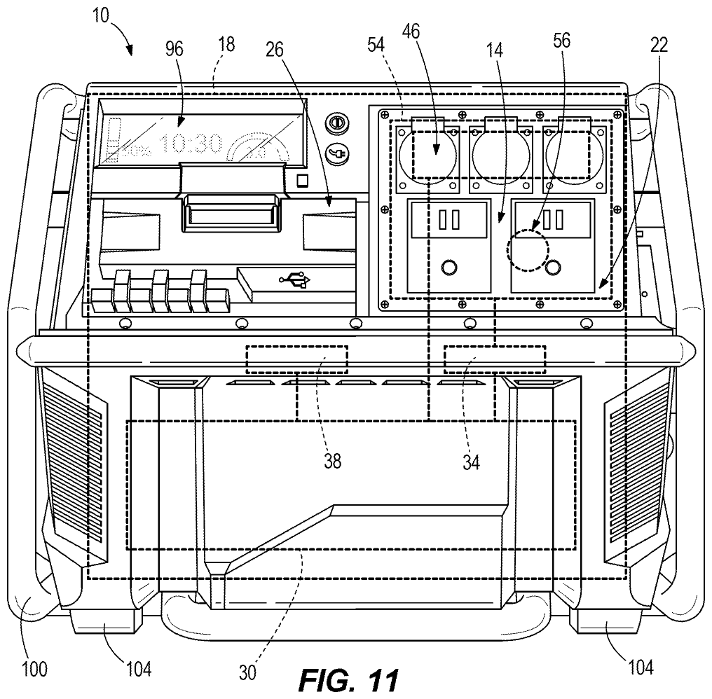

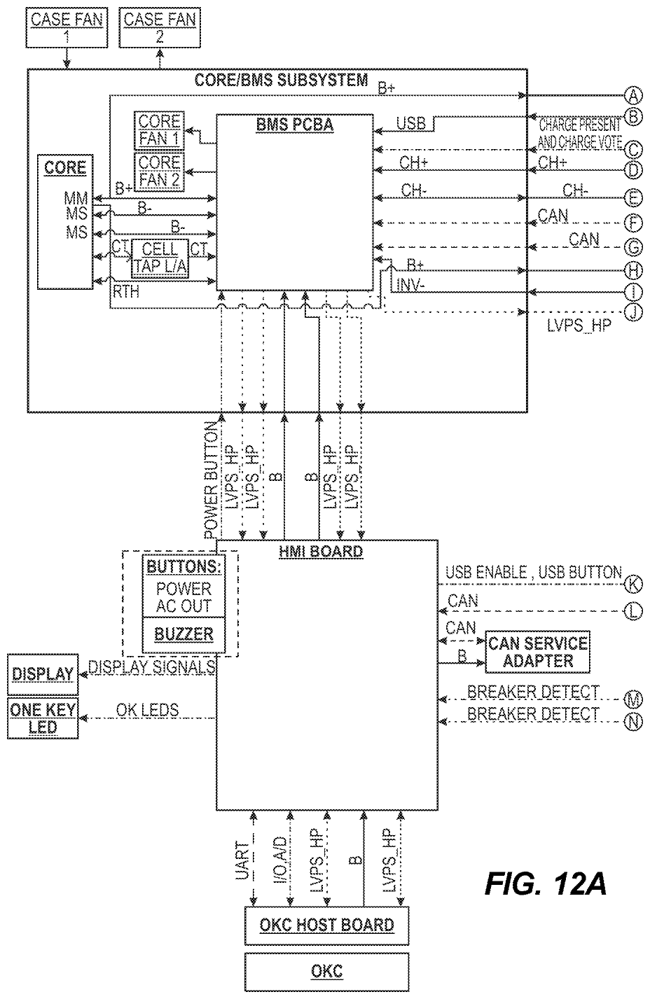

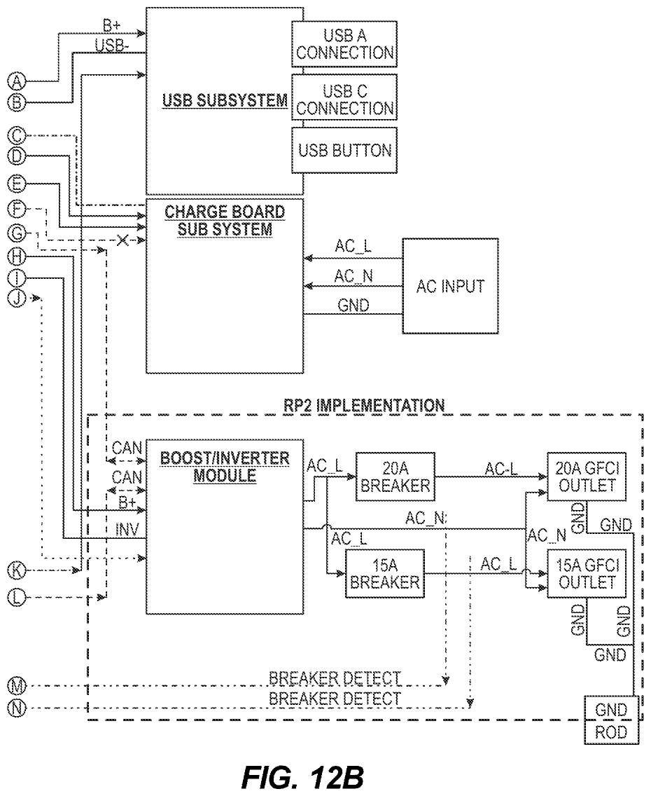

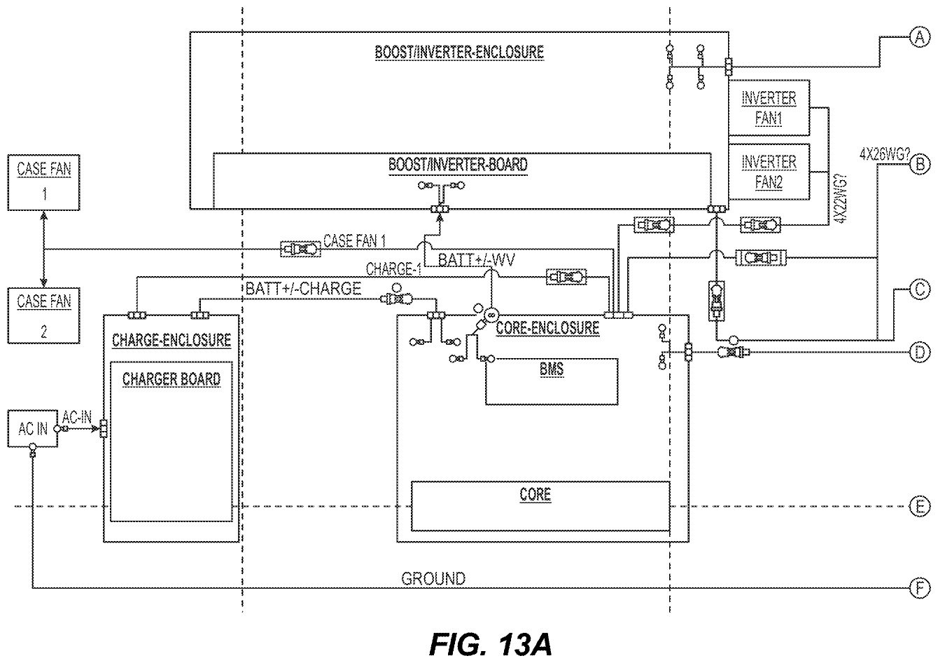

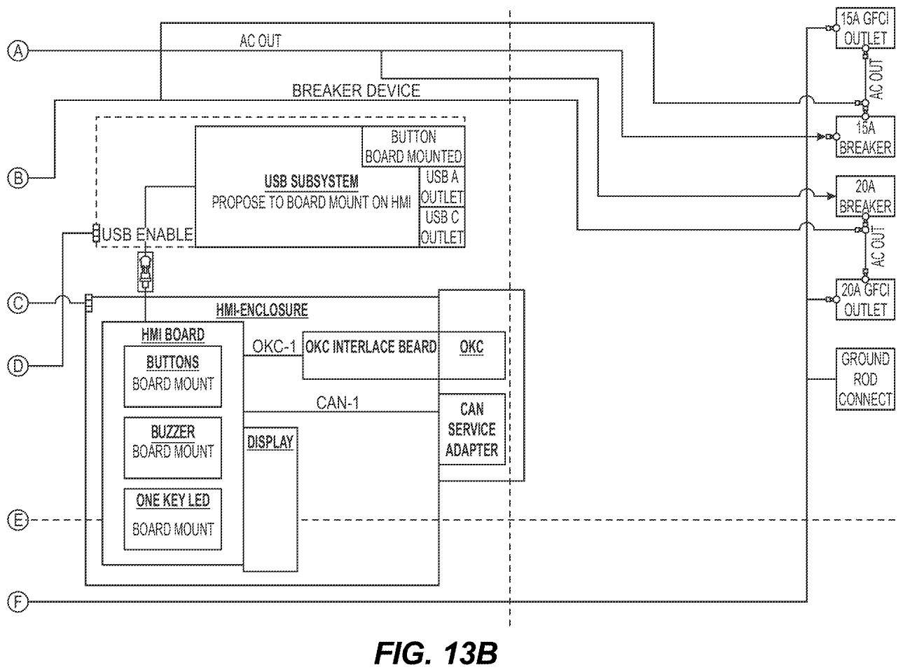

With reference to FIG. 11, another exemplary embodiment of the portable power supply 10 is shown. The portable power supply 10 includes a housing 18, which defines a cavity 26. The housing 18 is made of a durable material, such as metal or plastic, that can withstand dents, scratches, and other wear-and-tear common to a worksite. A display 96 is coupled to the housing 18. The display 96 is a liquid crystal display (LCD) or other appropriate display. The display 96 provides visual information, which could include, but is not limited to the present time, the amount of charge remaining for the portable power supply 10, battery temperature, and icons indicating status of the portable power supply 10 and electrically connected devices. Other alternative displays could be included, such as an analog gauge, indicator lights, and other appropriate visual indicators.

Disposed in the cavity 26 are a plurality of battery cells 30. The battery cells 30 are capable of being recharged by an external power source, such as an extension cord from an electrical outlet providing mains power. The battery cells 30 may be lithium ion battery cells or another appropriate battery cell construction that is capable of being recharged.

An inverter 38 is also disposed in the cavity 26. The inverter 38 is electrically coupled to the plurality of battery cells 30. Power is provided from the battery cells 30 to the inverter 38. The power from the battery cells 30 is provided as a direct current, which the inverter 38 converts to an alternating current for use by AC powered tools or other equipment that can be plugged into an outlet 46.

The portable power supply 10 also includes a junction box 54. The junction box 54 has a plurality of walls 92 that define a recess 58. A hole 56 is provided in at least one of the plurality of walls 92. The hole 56 allows fluid communication between the recess 58 and the cavity 26. The junction box 54 may be made of a metallic material, durable plastic, or the like.

The portable power supply 10 also includes an outlet panel 14. The outlet panel 14 is electrically coupled to the plurality of battery cells 30. The outlet panel 14 is removably coupled to the junction box 54 by a plurality of fasteners 42. The fasteners 42 may be screws, bolts, or the like, which correspond with a plurality of fastening locations 66 in the junction box 54. The present embodiment includes ten fasteners 42 to removably connect the outlet panel 14 to the junction box 54, but another quantity that sufficiently secures the outlet panel 14 can be used.

The outlet panel 14 may include at least one outlet 46 to which a power tool or other electrically powered device can be connected. The outlet 46 may be a NEMA outlet 46 such as a NEMA 5-15R outlet commonly found in residential and commercial settings in the United States. Other NEMA standard compliant outlets commonly found in the United States may also be used. Alternatively, outlets 46 that are common in other regions of the world, such as a CEE 7/3 outlet, may be used as well. The outlet panel 14 could also include different outlets 46, such as an outlet with a maximum current rating of fifteen amps and another outlet having a maximum current rating of twenty amps. The outlet 46 is coupled to the outlet panel 14 by screws, clips, or other joining methods.

The portable power supply 10 also includes a plurality of wires 50 that electrically couple the outlet panel 14 to the plurality of battery cells 30. The plurality of wires 50 are connected to the outlet panel 14 at a screw terminal 52 of the outlet 46. The plurality of wires 50 electrically couple the outlet panel 14 to the battery cells 30 via the inverter 38. A grommet may be coupled to the hole 56 of the junction box 54. The grommet provides an interface at the hole 56, through which a wire or plurality of wires 50 could be fed for electrically coupling the inverter 38 with the outlet panel 14. The plurality of wires 50 extend from the inverter 38 in the cavity 26 and pass through the hole 56 in the junction box 54, with an interface through the grommet, and extend through the recess 58 of the junction box 54. When the modular outlet panel 14 is installed, additional length of the plurality of wires 50 may be disposed in the cavity 26 or may be disposed in the recess 58 of the junction box 54 behind the outlet panel 14.

Surrounding the housing 18 of the portable power supply 10 is a frame 100. The frame 100 consists of rectangular or circular tubular members. It may consist of a plurality of members that are welded together to form a single, tubular structure. Alternatively, the tubular members may be connected by threaded fasteners, rivets, or other appropriate joining techniques. The frame 100 is coupled to the housing 18 such that it at least partially surrounds the housing 18 and provides support and protection for the housing 18. The frame 100 may have a plurality of elastomeric members 104 attached thereto for providing a reduced-skid interface. The elastomeric members may be attached to the bottom of the frame 100. The frame 100 is connected to the housing 18 by threaded fasteners or other joining members.

What is claimed is:

1. A portable power supply comprising:
a housing including
an opening defined in the housing and
a cavity defined in the housing;
a plurality of battery cells disposed in the cavity;
a sensor electrically coupled to the battery cells;
an inverter electrically coupled to the battery cells, the inverter disposed in the cavity; and
a modular outlet panel removably coupled to the housing, the modular outlet panel disposed over a majority of the opening.

2. The portable power supply of claim 1, further comprising a screw terminal, the screw terminal disposed on the modular outlet panel for connecting a plurality of wires.

3. The portable power supply of claim 1, wherein the modular outlet panel includes a NEMA 5-15R outlet.

4. The portable power supply of claim 1, wherein the modular outlet panel includes a CEE 7/3 socket.

5. The portable power supply of claim 1, wherein
the sensor includes a switch arm,
the modular outlet panel includes a boss, and
the boss engages the switch arm.

6. The portable power supply of claim 5, wherein
the housing further comprises a junction box having an aperture defined therein, and
the boss is received through the aperture.

7. The portable power supply of claim 1, further comprising a frame at least partially enclosing the housing.

8. The portable power supply of claim 1, further comprising a plurality of fasteners, the fasteners coupling the modular outlet panel to the housing.

9. The portable power supply of claim 8, wherein the fasteners include screws.

10. The portable power supply of claim 1, wherein the battery cells include lithium ion battery cells.

11. The portable power supply of claim 1, further comprising a USB outlet disposed in the housing, the USB outlet being electrically coupled to the battery cells.

12. The portable power supply of claim 11, wherein the USB outlet receives direct current power from the battery cells and the modular outlet panel receives AC power from the inverter.

13. A portable power supply comprising:
a housing including
a cavity defined therein and
a junction box including
a plurality of walls defining a recess, the walls at least partially separating the recess from the cavity and
a hole defined in at least one of the walls, the hole fluidly communicating the recess with the cavity;
a plurality of battery cells disposed in the cavity;
a sensor electrically coupled to the battery cells, the sensor disposed adjacent at least one of the walls of the junction box; and
an inverter electrically coupled to the battery cells, the inverter disposed in the cavity.

14. The portable power supply of claim 13, wherein the sensor includes a mechanical switch.

15. The portable power supply of claim 13, wherein the junction box is configured to receive a plurality of fasteners.

16. The portable power supply of claim 13, further comprising a receptacle disposed in the housing and electrically coupled to the battery cells, the receptacle receiving a mains electric power.

17. The portable power supply of claim 13, further a comprising a frame, the frame at least partially enclosing the housing.

18. The portable power supply of claim 13, wherein the battery cells include lithium ion battery cells.

19. A portable power supply comprising:
a housing including
a cavity defined therein and
a junction box including a plurality of walls defining a recess, at least one of the walls having a hole defined therein, the hole fluidly communicating the recess with the cavity;
a display coupled to the housing;
a plurality of battery cells disposed in the cavity;
an inverter disposed in the cavity and electrically coupled to the battery cells; and
an outlet electrically coupled to the inverter and removably coupled to the junction box.

20. The portable power supply of claim 19, further comprising a frame disposed around the housing.
